(19) United States
(12) Patent Application Publication
(10) Pub. No.: US 2005/0233109 A1
(43) Pub. Date: Oct. 20, 2005

(54) Bottle closure

(76) Inventor: Jeanine Hettinga, Des Moines, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 10/825,006

(22) Filed: Apr. 15, 2004

(51) Int. Cl. B32B 7/00

(52) U.S. Cl. 428/119

(57) ABSTRACT

A bottle closure formed by injection molding and including a body member having a generally cylindrical portion and at least one generally circular end portion; and markings such as designs, logos, or other identifying information molded into the end portion during the injection molding process. The bottle closures are molded using one or more pins having face plates that are releasably positioned in a mold cavity and are formed with the reverse of the markings. The plates are adapted to be specific to the producer of the contents of the bottle and are quickly and easily swapped in and out of the mold cavity to permit a single mold cavity to be used to produce a variety of customized bottle closures. The closure may be of any desired shape, including the generally cylindrical used, for example in wine bottles, or T-shaped in longitudinal cross section, referred to in the industry as “T tops”, used, for example, in bottles of spirits, vinegars, oils, and the like.

### BACKGROUND OF THE INVENTION

1. Field of the Invention

This invention relates to bottle closures for sealing bottles, and more particularly, to an injection molded bottle closure having designs, logos, markings, identifying information, or the like molded into the ends of the closure at the time of molding.

2. Background of the Prior Art

Traditionally wood cork comprises the most common material for bottle closures. However, continued increases in demand for cork increase the cost of cork, and place a strain on the diminishing supply of cork-producing trees. At least ten percent of bottles today with wood corks are reported to suffer from cork taint caused by 2,4,6-trichloroanisole, or TCA, a fungus-produced compound that grows in cork fiber. TCA causes the musty or moldy odor that can spoil the wine. When the chips or dust of wood cork is used in the manufacture of wood cork agglomerate closures, the TCA can again cause cork taint. Further, variations in the color, compressibility, and rigidity of cork renders a substantial amount of cork unusable for use in bottle closures. Hence, there exists a need for a suitable alternative to natural cork bottle closures.

Synthetically generated bottle closures are well known in the art, some even utilize thermoplastic resins and blowing agents to create a dense outer skin and a low density interior. U.S. Pat. No. 5,692,629 discloses such a product. These types of bottle closures, however, suffer from several drawbacks. Synthetic bottle closures typically have rough outer surfaces. These surfaces prevent the bottle closure from forming a strong uniform seal of the bottle. A deficient seal allows for leakage of the contents of the bottle, and provides an opportunity for contaminates to enter the bottle. Additionally, the rough appearance renders the bottle closure less aesthetically pleasing. The rough appearance generally results from imperfections in the cellular structure of the bottle closure. Voids and fissures created during the injection molding process provide areas where contaminants can collect, and provide an environment for the growth of bacteria. U.S. Pat. No. 6,139,934, teaches a method of forming bottle closures out of plastic that has a higher cellular density near the surface and a lower cellular density near the core and address many of the problems in the art.

Bottle closures for wine have traditionally been printed (plastic) or branded (wood) with designs, words, logos and other markings that identify the producer of the wine and perhaps the wine itself. This information has been limited to printing on the surface of the closure body and has not included engraving or imprinting on the ends of the closure. Moreover, these markings are applied by traditional printing techniques after the cork closure has been produced, for example, as described in U.S. Pat. No. 5,904,965. In order to mark the top of a bottle which received a cork closure, the practice has been either to add a foil, plastic, or paper cover. U.S. Pat. No. 5,553,728 describes a thermoplastic disc that is inserted into the neck of a bottle atop the closure and which can be printed or embossed with designs or words. Recently, some bottlers have been recessing the closure in the bottle neck and then placing molten wax atop the closure and imprinting the wax with a design or other marking. These prior art methods require additional steps to be performed after the bottle closure has been inserted and so have the disadvantages of being expensive, time consuming, and requiring additional equipment that must be purchased, installed, and maintained.

Accordingly, there exists a need for an injection molded bottle closure having end surfaces that displays markings, designs, logos, bottler information and the like that are molded into the closure at the time of manufacture and which are visible after insertion of the closure into the bottle without the need for further equipment or processing.

### SUMMARY OF THE INVENTION

An object of the present invention comprises providing an injection molded bottle closure having one or more ends carrying a molded-in imprint.

Another object of the present invention comprises providing an injection molded bottle closure which visibly displays markings, designs, logos, seller information, and the like upon insertion of the closure into a bottle.

Yet another object of the present invention comprises providing a method for injection molding customized bottle closures using replaceable mold inserts that permit the quick and easy changes to be made to the mold cavity and consequently to the molded bottle closures.

Still another object of the invention is to provide a mold insert for imprinting or engraving markings on the end surface of a closure during molding of the closure and which has a concave or convex surface curvature to impart a convex or concave surface curvature, respectively, to the end of the closure.

These and other objects of the present invention will become apparent to those of ordinary skill in the art upon reference to the following specification, drawings, and claims.

The present invention proposes to overcome the difficulties encountered heretofore. To this end, a bottle closure is molded according to an injection molding process that utilizes a first mold section and a second mold section which, upon contact engagement with each other, form a mold cavity in which the closure is formed. Formed into at least one of the end portions of the mold sections is the reverse or negative of a customized design, marking, logo, or other identifying information that is formed in on at least one of the ends of the closure. In a preferred embodiment, the negative design is formed on the end of one or both of a pair of replaceable pins which are received in either of the mold sections. The information is either in the form a raised portion of the face of the pin, depressed portions of the face of the pin, or a combination of both. An injection mixture is injected into a mold cavity formed between the first and second mold sections. Upon satisfactory cooling of the injection mixture, the formed closure is ejected from the mold. The end of the closure that formed in contact with a pin carrying the negative design or other identifying information will carry a positive impression of the design or identifying information.

### BRIEF DESCRIPTION OF THE DRAWINGS

FIG. 1 is a side elevation view of an injection molding machine.

FIG. 2 is a cross-sectional view of the mold unit of the injection molding machine of FIG. 1 for molding a cylindrical bottle closure such as a wine bottle closure and showing a pair of removable pins for forming impressions or markings on one or both of the ends of the bottle closure.

FIG. 3 is a cross-sectional view of the mold unit of the injection molding machine of FIG. 1 for molding a bottle closure having a substantial T-shape in cross-section, such as a bottle closure for a liquor and condiment bottles requiring a T top closure, and showing a pair of removable pins for forming impressions on the ends of the bottle closure.

FIG. 4 is end view of a removable pin of FIG. 2 showing the negative impression of a logo.

FIG. 5 is a side view of a T top closure of the present invention.

FIG. 6 is a perspective view of a cylindrical closure of the present invention.

### DETAILED DESCRIPTION OF THE INVENTION

Although this specification describes a particular type of plastic injection molding apparatus for manufacturing closures of the present invention, those skilled in the art will recognize that a wide variety of plastic injection molding machines can be used in the manufacture of these closures.

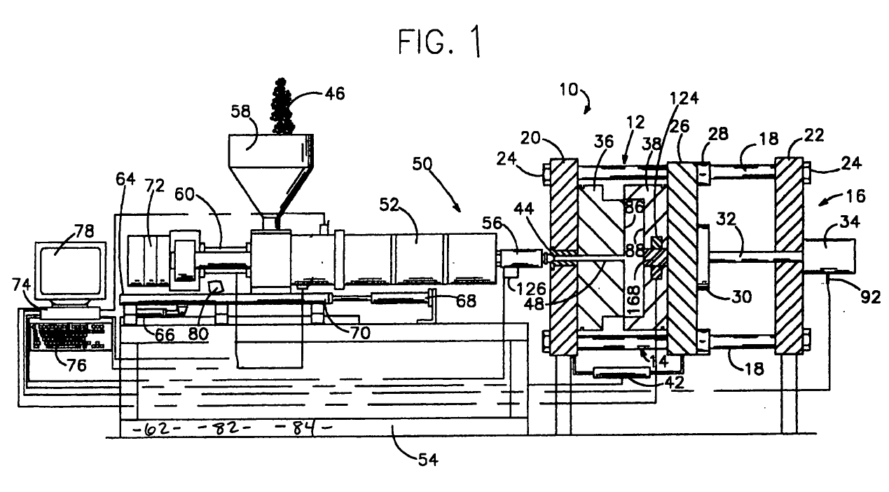

Referring to the drawings, a mold apparatus 10 is shown including a mold unit 12, a mold frame 14, and a hydraulic piston 16 (FIG. 1). The mold frame 14 consists of four cylindrical support bars 18 which are secured to a first plate 20 and to a second plate 22 by means of nuts 24. A mold carriage 26 is slideably attached to the support bars 18 through bores which pass through the corners of the mold carriage 26. Support blocks 28 are provided with bores and mounted to the corners of the mold carriage 26 to add extra support to the mold carriage 26 as it slides along the support bars 18. A platen 30 is secured to the mold carriage 26 to evenly distribute force over the mold carriage 26. Secured to the platen 30 is a piston ram 32. The piston ram 32 passes through a bore in the center of the second plate 22 and is connected to a hydraulic cylinder 34. The hydraulic cylinder 34, piston ram 32, traverse valve 92, and volumetric variable hydraulic pump make up the hydraulic piston 16. The hydraulic piston 16 is in connection with a central processing unit 74, and can be controlled through the central processing unit 74.

A first mold section 36 is mounted to the first plate 20 in alignment with a second mold section 38 which is mounted to the mold carriage 26. As the hydraulic piston 16 pushes the mold carriage 26 toward the first plate 20, the first mold section 36 fits into seated engagement with the second mold section 38 to form a mold cavity 40 therebetween. The second mold section 38 has an ejector pin 168, which is advanced after a plastic article has been formed to eject the article from the mold cavity. The ejector pin 168 can be moved hydraulically, pneumatically, electrically, servo-electrically, or by any other suitable or equivalent means.

A nozzle inlet 44 is located in the center of the first plate 20 to allow an injection mixture 46 to pass into a mold inlet 48 located in the first mold section 36 and thereafter into the mold cavity 40.

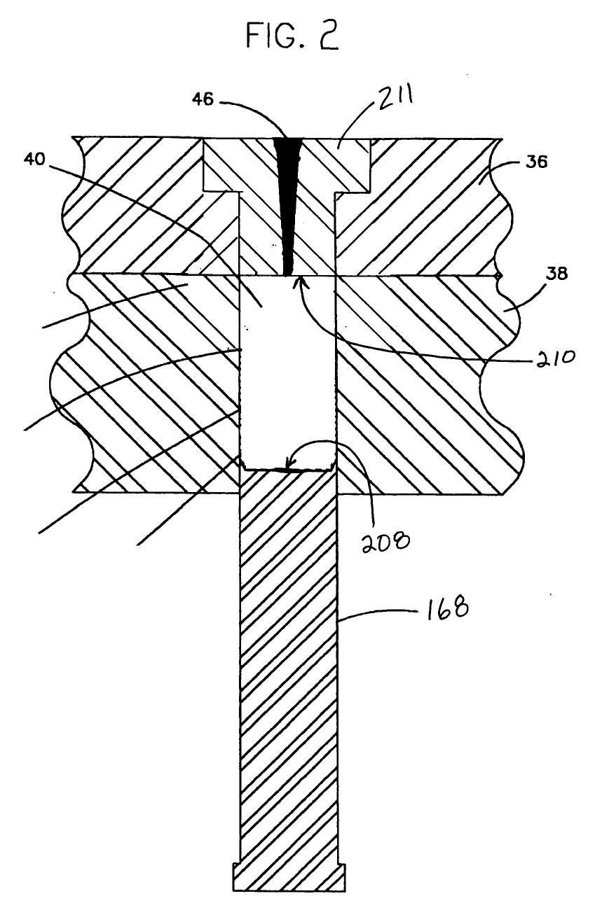

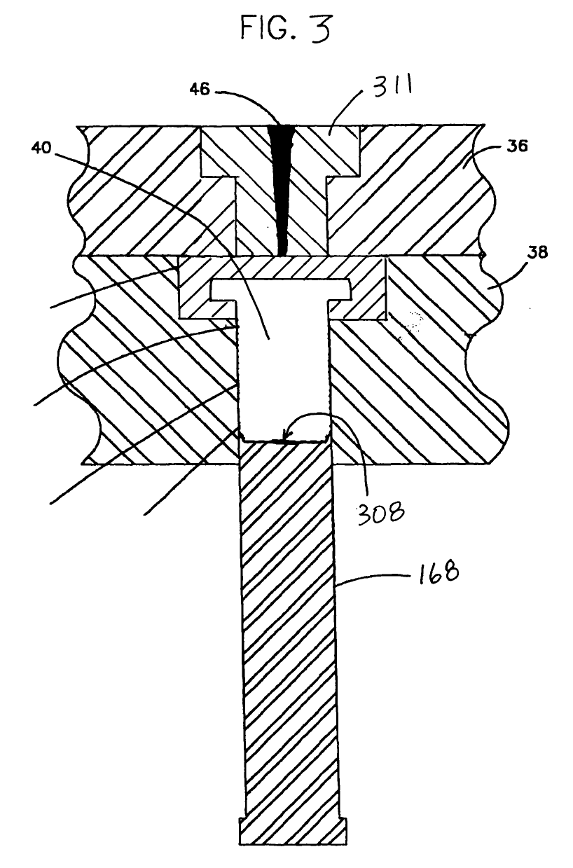

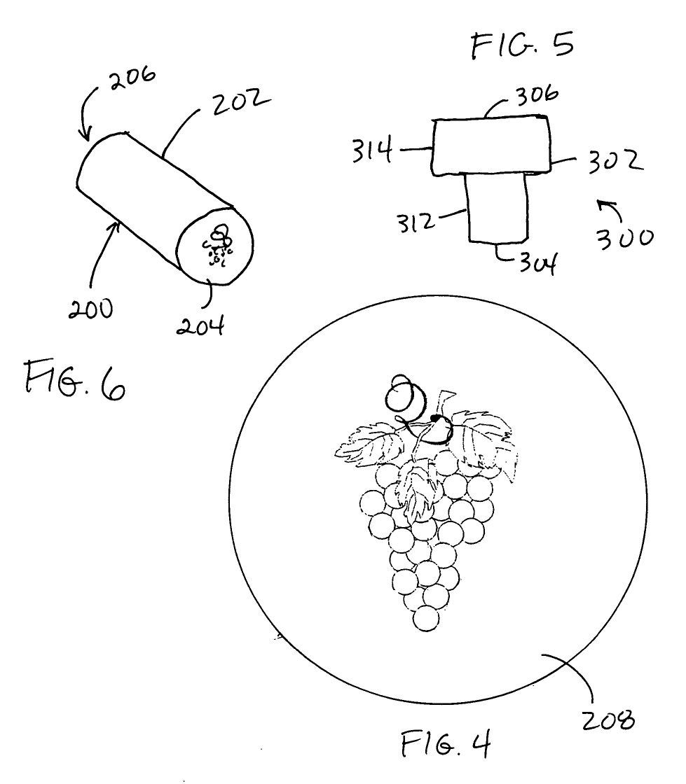

Provided for operable engagement with the nozzle inlet 44 is an injection assembly 50 which prepares and injects the injection mixture 46 into the mold cavities 40 (FIG. 1, FIG. 2). The injection assembly 50 is provided with an injection barrel 52 supported by a main frame 54. A nozzle unit 56 is mounted at one end of the injection barrel 52 and a hopper 58 is mounted to the top of the injection barrel 52. Positioned coaxially within the injection barrel 52 is a reciprocating screw 60 with attached flights (not shown) for plasticizing and moving the injection mixture 46 toward the injection barrel 52 and nozzle unit 56. A variable volume, pressure compensated hydraulic pump 62 is secured to the injection barrel 52 and operates to move the injection screw 60 relative to the injection barrel 52 during the injection molding process. The injection assembly 50 is provided with a large rotational motor 72 which turns the injection screw 60 to plasticize the injection mixture 46 before injection.

The nozzle unit 56 is movable into and out of operative association with the nozzle inlet 44 upon a reciprocal movement of a carriage 64 relative to the main frame 54. This reciprocal movement is responsive to the operation of a double acting cylinder 66 pivotally interconnected between the carriage 64 and the main frame 54. The operation of the double acting cylinder 66 is controlled by a second linear transducer 68 mounted on the mainframe 54.

The injection assembly 50 is operably coupled to the central processing unit 74 which monitors the progress of the injection process and feeds back responsive information regarding this progress to the injection assembly 50 (FIG. 1). In a preferred embodiment the central processing unit 74 is a personal computer, but the central processing unit 74 may, of course, be any system capable of receiving user input variables, monitoring the progress of a plastic injection run, and controlling the injection in response thereto. The central processing unit 74 is equipped with an input device 76 and a viewing screen 78. To monitor the rate of injection mixture 46, a shot size transducer 80 is coupled to the injection screw 60 to monitor the distance that the injection screw 60 travels. The shot size transducer 80 is a linear transducer which correlates movement of the injection screw 60 to a predetermined amount of the injection mixture 46 injected into the mold cavity 40. The shot size transducer is connected to the central processing unit 74 in order to give feedback to the central processing unit 74. As each incremental amount of the injection mixture 46 within the injection assembly 50 is injected into the mold cavity 40, the shot size transducer 80 monitors the associated incremental movement of the injection screw 60. Preferably the shot size transducer 80 measures increments of injection mixture 46 of one gram or less, which translates into approximately four thousand increments for a typical molding operation.

To monitor the pressure at which the injection mixture 46 is injected into the mold cavity 40, a pressure monitor 82 is operably coupled to the hydraulic pump 62 (FIG. 1). The pressure monitor 82 is also coupled to the central processing unit 74. The central processing unit 74 is operably coupled to an injection control 84 which is, in turn, coupled to the hydraulic pump 62 to manipulate the injection of the injection mixture 46.

At the beginning of the molding process the hydraulic piston 16 is actuated to force the piston ram 32 toward the first plate 20. The platen 30 disburses the force of the piston ram 32 to the mold carriage 26 and the second mold section 38. The second mold section 38 is moved into engagement with the first mold section 36 to form a mold cavity 40.

The injection mixture 46 may include a blowing agent mixed with a plastic injection material, as described in U.S. Pat. No. 6,139,934, the disclosure of which is incorporated herein by this reference. The injection mixture 46 is heated to an injection temperature and injected into the molding cavities 40. The injection temperature is hot enough to plasticize the injection mixture 46, and hot enough that the blowing agent will decompose, or be activated, unless the injection mixture 46 is pressurized. In the preferred embodiment the injection temperature is approximately 400 degrees Fahrenheit.

Before the injection mixture 46 is injected into the mold cavity 40, it is first plasticized to provide a flowable material which eventually hardens into a finished plastic article. The following parameters affect the plasticization process: the type of raw plastic material to be plasticized, throat temperature, the temperature of injection assembly heating zones, the size, length and type of screw 60, the rate at which the screw 60 is turned, and the rate at which the screw 60 is allowed to move back.

Like the plasticization process, the injection process is also controlled by the computer control program. The parameters associated with the injection process include the following: the type of raw injection mixture 46 to be injected; the temperature of the injection mixture 46; the size, length and type of screw 60; the rate at which the injection mixture 46 is injected; the mold design; and the mold temperature. Preferably, both the temperature of the injection mixture 46 and the rate at which the injection mixture 46 is injected are controlled by the computer control program. The computer control program also controls the movement of the ejector pin 168.

A common shape of bottle closures is the substantially cylindrical shape illustrated in FIG. 3 generally at 200. This type of closure is typically used in bottles of wine. It has a body member 202 that has a generally cylindrical surface and includes a pair of generally circular end portions 204 and 206. In accordance with the present invention, it is desired to mold into one or both of the end portions 204, 206 markings which will be visible upon insertion of the closure 200 into a bottle. For this purpose, a negative impression of the markings have been formed in the face 208 of the ejector pin 168. The face 208 has a pattern of raised areas, depressed areas, or combinations of both so that upon molding of the closure 200 in the mold cavity in contact with the face 208, the “positive” form of the marking will be molded into an end portion of the closure 200.

The bottle closure 200 is commonly used by bottlers with bottling machinery which automatically insert the closures 200 into the necks of bottles. Since the closures 200 are symmetrical about a central transverse axis, they can be inserted either with end portion 204 facing the interior of the bottle and end portion 206 facing the exterior of the bottle or reversed wherein end portion 204 faces the exterior of the bottle and end portion 206 faces the interior of the bottle. Accordingly, it is desired that a face 210 of a sub gate pin 211 be releasably secured in the first mold section 32 so that both end portions of the closure 200 will carry the desired markings to ensure that the end portion that is visible outside of the bottle will always display the marking. Face 210 is formed with the same negative marking as face 208, but is also provided with a small central opening 212 through which the plasticized injectable material can be introduced into the mold cavity. After the closure 200 has been molded and cooled sufficiently, the mold is opened and the closure 200 is ejected from the mold cavity 40 by the ejector pin 168 in the conventional manner.

An alternative application of the closures of the present invention is to what is known in the industry as a “T top” an example of which is illustrated in FIG. 5 generally at 300. Closures 300 have a body member 302 that includes a pair of end portions 304 and 306 as well as a generally cylindrical surface 312 and an enlarged section 314, thereby presenting a longitudinal cross section that is substantially T-shaped. Rather than being inserted fully into the neck of a bottle, closures 300 are inserted with only the smaller diameter surface 312 inside the neck of the bottle and the enlarged section 314 remaining outside the bottle and serving as a handle by which the closure 300 may be removed and reinserted into the bottle. In the prior art, the enlarged section 314 is molded of a hard, non-resilient plastic material and the smaller diameter section 312 is made of wood cork. In the present invention, the smaller diameter section 312 is molded of the resilient plastic material used for making of the closures 200. As illustrated in FIG. 3, the enlarged diameter section 314 is inserted into the mold cavity and the smaller diameter section 312 is molded partially inside of it.

According to the present invention, either or both end portions 304, 306 of the closure 300 may be formed with markings by the use of an ejector pin 168 and corresponding face 308 and a sub gate pin 311 and corresponding face 310, which are sized to correspond to the size of the end portions 304 and 306, respectively, but are otherwise as described previously with respect to the faces 208 and 210. The faces 208, 210, 308, and 310 are shown as being planar. The faces, however, can be either concave or convex in order to form a closure having a conversely shaped end portion. For example, the face 210 for use in forming the top end portion of a closure 200 may have a concave face on which the markings are formed and will thereby result in the formed closure having a raised or arched top.

While the preferred embodiment of the invention herein described makes use of pins that may be easily and quickly swapped into and out of the mold cavity, the full concept of the invention includes forming the “negative” markings on disks that are releasably secured to the ends of the pins 168 and 211.

The foregoing description and drawings merely explain and illustrate the invention, and the invention is not limited thereto, except insofar as the claims are so limited as those skilled in the art who have the disclosure before them will be able to make modifications and variations therein without departing from the scope of the invention. For example, it is anticipated that the mold unit can be configured with more than one retractable mold portion thereby enabling the creation of several injection molded bottle closures at one time.

1. A bottle closure formed by injection molding, comprising:
(a) a body member having a generally cylindrical portion and at least one generally circular end portion; and
(b) markings molded into the end portion during the injection molding process.

2. A bottle closure as defined in claim 1, wherein the markings are selected from the group consisting of designs, logotypes, names, information identifying the contents of the bottle, and information identifying the producer of the contents of the bottle.

3. A bottle closure as defined in claim 1, wherein the body member has two generally circular end portions, the markings are molded into each end portion during the injection molding process, and the markings are substantially identical.

4. A bottle closure as defined in claim 1, further comprising an enlarged portion of the body member.

5. A bottle closure as defined in claim 4, wherein the body member is substantially T-shaped in longitudinal cross section.

6. A method of injection molding a bottle closure, comprising the steps of:
(a) providing an injection molding machine having a mold cavity for molding a bottle closure comprising a body member having a generally cylindrical portion and at least one generally circular end portion;
(b) creating a plate with reverse markings;
(c) releasably securing the plate in the mold cavity adjacent the portion of the mold cavity forming the end portion;
(d) injecting an injection mixture into the mold cavity; and
(e) discharging a bottle closure having positive markings on one or both of its end portions.

7. A method as defined in claim 6, wherein the markings are selected from the group consisting of designs, logotypes, names, information identifying the contents of the bottle, and information identifying the producer of the contents of the bottle.

8. A method as defined in claim 6 wherein the body member has two generally circular end portions, further comprising the steps of:
(a) forming the reverse markings into a second plate; and
(b) releasably securing the second plate in the mold cavity adjacent the portion of the mold cavity forming the second end portion to create substantially identical markings in the second end portion.

9. A method as defined in claim 6, further comprising an enlarged portion or the body member.

10. A method as defined in claim 9, wherein the body member is substantially T-shaped in longitudinal cross section.
